(19) United States
(12) Patent Application Publication
(10) Pub. No.: US 2026/0140265 A1
(43) Pub. Date: May 21, 2026

(54) METHOD AND DEVICE FOR DETECTING OBSTACLE, MEDIUM AND ELECTRONIC DEVICE

(71) Applicant: AIRBUS (BEIJING) ENGINEERING CENTRE COMPANY LIMITED, Beijing (CN)

(72) Inventors: Shiwen HE, Beijing (CN); Xiao WANG, Beijing (CN); Jinming HUANG, Beijing (CN)

(21) Appl. No.: 19/120,692

(22) PCT Filed: Oct. 12, 2023
(86) PCT No.: PCT/CN2023/124144

§ 371 Date: Apr. 11, 2025

(30) Foreign Application Priority Data
Oct. 12, 2022 (CN) 202211244084.4

(51) Int. Cl. G01S 17/931; G01S 7/48; G01S 17/933

(52) U.S. Cl. CPC G01S 17/931; G01S 7/4802; G01S 7/4808; G01S 17/933

(57) ABSTRACT

A method and a device for detecting an obstacle, a computer-readable storage medium and an electronic device are disclosed including determining a global point cloud Cwt corresponding to a t-th time instant based on point cloud data obtained by a laser radar at the t-th time instant; determining an object point cloud Cot corresponding to the t-th time instant based on a rotation matrix corresponding to the t-th time instant and a standard point cloud corresponding to a moving object. The determination of the object point cloud Cot corresponding to the t-th time instant includes estimation of an attitude of the moving object, which ensures the safety of the moving object. Further, a to-be-measured point cloud Cdt corresponding to the t-th time instant is determined based on the global point cloud Cwt and the object point cloud Cot corresponding to the t-th time instant.

This application claims priority to Chinese Patent Application No. 202211244084.4, titled “Method and device for detecting obstacle, medium and electronic device”, filed on Oct. 12, 2022 with the China National Intellectual Property Administration, which is incorporated herein by reference in its entirety.

### FIELD

The present disclosure relates to the technical field of intelligent navigation, and in particular to a method and a device for detecting an obstacle, a computer-readable storage medium and an electronic device.

### BACKGROUND

There may be many obstacles on a path that an object passes through during movement of the object. However, there may be an obstacle that cannot be accurately determined due to visual dead corners for the moving object. For example, when an aircraft moves in an airport under drag of a tractor, a complex integrated ground environment interferes with the aircraft moving on the ground. In addition, factors, such as a size of the aircraft, cause low efficiency determination of the obstacle on the ground by traction staff, resulting in low efficiency traction for the aircraft.

It should be noted that information disclosed in the Background is only used for understanding the background of the present disclosure, and therefore, may include information that does not constitute conventional technology known by those skilled in the art.

### SUMMARY

An objective of the present disclosure is to provide a method and a device for detecting an obstacle, a computer-readable storage medium and an electronic device, to improve accuracy of detecting an obstacle and the efficiency of traction for a moving object to some extent.

Other features and advantages of the present disclosure will become apparent through the following detailed description, or will be learned in part through the practice of the present disclosure.

According to an aspect of the present disclosure, a method for detecting an obstacle is provided. The method includes: determining a global point cloud C_{wt} corresponding to a t-th time instant based on point cloud data obtained by a laser radar at the t-th time instant, where t is a positive integer; determining an object point cloud Cₒₜ corresponding to the t-th time instant based on a rotation matrix corresponding to the t-th time instant and a standard point cloud corresponding to a moving object; determining a to-be-measured point cloud C_{dt} corresponding to the t-th time instant based on the global point cloud C_{wt} and the object point cloud Cₒₜ corresponding to the t-th time instant; and determining an obstacle for the moving object at the t-th time instant based on the to-be-measured point cloud C_{dt} corresponding to the t-th time instant and a safety area Rt corresponding to the t-th time instant.

According to another aspect of the present disclosure, a device for detecting an obstacle is provided. The device includes: a global-point-cloud determination module, an object-point-cloud determination module, a to-be-measured-point-cloud determination module, and an obstacle determination module.

The global-point-cloud determination module is configured to determine a global point cloud C_{wt} corresponding to a t-th time instant based on point cloud data obtained by a laser radar at the t-th time instant, where t is a positive integer. The object-point-cloud determination module is configured to determine an object point cloud Cₒₜ corresponding to the t-th time instant based on a rotation matrix corresponding to the t-th time instant and a standard point cloud corresponding to a moving object. The to-be-measured-point-cloud determination module is configured to determine a to-be-measured point cloud C_{dt} corresponding to the t-th time instant based on the global point cloud C_{wt} and the object point cloud Cₒₜ corresponding to the t-th time instant. The obstacle determination module is configured to determine an obstacle for the moving object at the t-th time instant based on the to-be-measured point cloud C_{dt} corresponding to the t-th time instant and a safety area Rₜ corresponding to the t-th time instant.

According to another aspect of the present disclosure, an electronic device is provided. The electronic device includes a memory, a processor, and a computer program stored on the memory and executable by the processor. The processor executes the computer program to implement the method for detecting an obstacle described above.

According to another aspect of the present disclosure, a computer-readable storage medium storing a computer program is provided. The computer program is executed by a processor to implement the method for detecting an obstacle described above.

The method for detecting an obstacle, the device for detecting an obstacle, the computer-readable storage medium and the electronic device according to the embodiments of the present disclosure have the following technical effect.

In the technical solution according to the present disclosure, on the one hand, a global point cloud C_{wt} corresponding to a t-th time instant is determined based on point cloud data obtained by a laser radar at the t-th time instant. On the other hand, an object point cloud Cₒₜ corresponding to the t-th time instant is determined based on a rotation matrix corresponding to the t-th time instant and a standard point cloud corresponding to a moving object. It can be seen that the determination of the object point cloud Cₒₜ corresponding to scuh a time instant for the moving object includes estimation of an attitude of the moving object, which ensures the safety of the moving object. Further, a to-be-measured point cloud C_{dt} corresponding to the time instant is determined based on the global point cloud C_{wt} and the object point cloud Cₒₜ obtained in the above two aspects. Finally, an obstacle for the moving object at the time instant is determined based on the to-be-measured point cloud C_{dt}. It can be seen that the present technical solution can automatically detect obstacles corresponding to different time instants respectively, has high accuracy in detecting an obstacle, and improves the traction efficiency while ensuring safety of the moving object.

It should be understood that the above general descriptions and the following detailed descriptions are merely for exemplary and explanatory purposes, and do not intent to limit the present disclosure.

### BRIEF DESCRIPTION OF THE DRAWINGS

The drawings herein are incorporated into the specification and constitute a part of the specification. The drawings show embodiments of the present disclosure. The drawings and the specification are intended to explain the principle of the present disclosure. Apparently, the accompanying drawings in the following description show merely some embodiments of the present disclosure, and those skilled in the art can obtain other drawings based on these accompanying drawings without creative efforts.

FIG. 1 is a schematic diagram showing a scenario of a scheme for detecting an obstacle according to an exemplary embodiment of the present disclosure;

FIG. 2 is a flowchart of a method for detecting an obstacle according to an exemplary embodiment of the present disclosure;

FIG. 3 is a schematic diagram showing a flexible connector according to an exemplary embodiment of the present disclosure.

FIG. 4 is a schematic diagram showing a scenario of a scheme for detecting an obstacle according to another exemplary embodiment of the present disclosure;

FIG. 5a is a flowchart of a method for determining a rotation matrix according to an embodiment of the present disclosure;

FIG. 5b is a flowchart showing a method for determining a rotation matrix according to another embodiment of the present disclosure.

FIG. 6 is a flowchart of a method for determining a to-be-measured point cloud according to an embodiment of the present disclosure;

FIG. 7 is a schematic diagram showing a safety area and a position relationship between the safety area and a to-be-measured target according to an embodiment of the present disclosure;

FIG. 8 is a flowchart of a method for detecting an obstacle according to another exemplary embodiment of the present disclosure;

FIG. 9 is a schematic diagram showing a width of the safety area according to an exemplary embodiment of the present disclosure;

FIG. 10 is a schematic diagram showing a method for determining a movement direction of a moving object according to an exemplary embodiment of the present disclosure;

FIG. 11 is a schematic structural diagram of a device for detecting an obstacle according to an embodiment of the present disclosure;

FIG. 12 is a schematic structural diagram of a device for detecting an obstacle according to another embodiment of the present disclosure; and

FIG. 13 is a schematic structural diagram of an electronic device according to an embodiment of the present disclosure.

### DETAILED DESCRIPTION OF EMBODIMENTS

To enable the objectives, technical solutions, and advantages of the embodiments of the present disclosure clearer, embodiments of the present disclosure are described in detail below with reference to the accompanying drawings.

When the following descriptions are made with reference to the drawings, unless indicated otherwise, same reference numbers in different drawings represent the same or similar elements. The implementations described in the following exemplary embodiments do not represent all implementations that are consistent with the present disclosure. On the contrary, the implementations are merely examples of devices and methods that are described in detail in the appended claims and that are consistent with some aspects of the present disclosure.

Exemplary embodiments are described more comprehensively with reference to the accompanying drawings. However, the exemplary embodiments may be implemented in multiple forms, and it is not to be understood as being limited to the examples described herein. On the contrary, the implementations are provided to make the present disclosure more comprehensive and complete, and comprehensively convey the idea of the exemplary embodiments to those skilled in the art. The described features, structures, or characteristics may be combined in one or more embodiments in any appropriate manner. In the following descriptions, a lot of specific details are provided to give a comprehensive understanding of the embodiments of the present disclosure. However, it is to be appreciated by those skilled in the art that one or more of the specific details may be omitted during practice of the technical solutions of the present disclosure, or other methods, components, devices, steps, or the like may be used. In other cases, well-known technical solutions are not shown or described in detail to avoid overwhelming the subject and thus obscuring various aspects of the present disclosure.

In addition, the accompanying drawings are merely exemplary illustrations of the present disclosure and are not necessarily drawn to scale. The same reference numbers in the accompanying drawings represent the same or similar parts, and therefore, repeated descriptions thereof are omitted. Some of the block diagrams in the accompanying drawings show functional entities and do not necessarily correspond to physically or logically independent entities. The functional entities may be implemented in the form of software, or implemented in one or more hardware modules or integrated circuits, or implemented in different networks and/or processor devices and/or micro-controller devices.

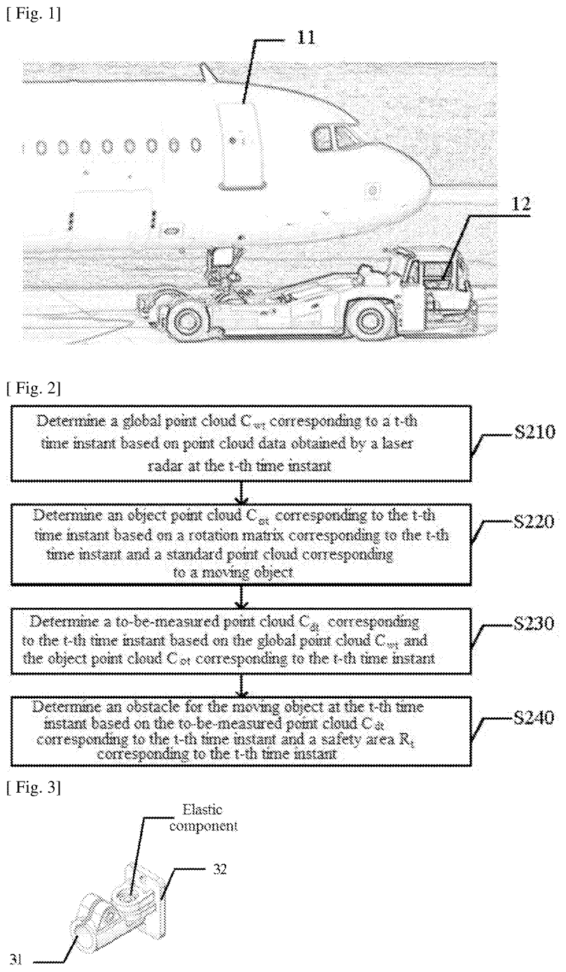

An embodiment of a method for detecting an obstacle according to the present disclosure will be described in detail below in conjunction with FIG. 1 to FIG. 10.

FIG. 1 is a schematic diagram showing a scenario of a scheme for detecting an obstacle according to an embodiment of the present disclosure. Referring to FIG. 1, the scenario includes an aircraft under traction (i.e., a moving object) 11 and a traction vehicle (i.e., a tractor) 12. In the embodiments of the present disclosure, a laser radar moves with the traction vehicle. For example, the laser radar is arranged on the tractor vehicle 12. It can be understood that in order to avoid damage to any part of the aircraft by an obstacle, scanning points of the laser radar are required to include points on the ground and scanning points on a fuselage and wings of the aircraft. A position where the laser radar is arranged, a height of a bracket of the laser radar, and a number of laser radars may be set or adjusted as needed (for example, a size of the traction vehicle, a size of the aircraft to which the tractor fits, physical parameters scanned by the laser radar, etc.), which are not limited in the embodiments of the present disclosure.

For example, first, a point cloud is obtained by the laser radar, and data such as the point cloud obtained by the laser radar and a standard point cloud corresponding to the aircraft 11 are transferred to a computation device. Further, for a t-th time instant (which may be a general time instant, for example, Beijing time 12:00 on Sep. 1, 2022, or timing during the traction, for example, a 10-th minute during the traction) during the aircraft moving under traction, the computation device determines an obstacle at this time instant. Specifically, a global point cloud C_{wt} corresponding to the time instant is determined based on point cloud data obtained by the laser radar at the time instant. An object point cloud Cₒₜ corresponding to the time instant is determined based on a rotation matrix corresponding to the aircraft at the time instant and a standard point cloud corresponding to the aircraft. Further, a to-be-measured point cloud C_{dt} corresponding the time instant is determined based on the global point cloud C_{wt} and the object point cloud Cₒₜ. An obstacle for the aircraft at the time instant during traction is determined based on the to-be-measured point cloud C_{dt}.

For example, for each time instant, an obstacle detected at the time instant and an attitude of the aircraft at the time instant may be displayed by a display device, for a user to observe and implement a corresponding adjustment measure.

In an exemplary embodiment, FIG. 2 is a flowchart of a method for detecting an obstacle according to an exemplary embodiment of the present disclosure. Referring to FIG. 2, the method includes steps: S210 to S240.

In step S210, a global point cloud C_{wt} corresponding to a t-th time instant is determined based on point cloud data obtained by a laser radar at the t-th time instant, where t is a positive integer.

It can be understood that multiple laser radars may be provided in the embodiments of the present disclosure. In a case that multiple laser radars are provided, it is required to obtain point clouds respectively captured by the multiple laser radars at a same time instant (at-th time instant). Further, in order to make the captured point clouds accurately reflect a real environment, it is further required to fuse the point clouds respectively captured by all the laser radars at the same time instant into a same coordinate system. In order to facilitate subsequent calculation, the point clouds captured by all the laser radars at a same time instant may be transformed into a coordinate system corresponding to the traction vehicle.

For example, serial numbers of the multiple laser radars may be expressed as: 1, . . . , N, and the multiple laser radars are represented by L₁, Lᵢ, . . . , L_{N}. A point cloud scanned by a laser radar Lᵢ with a serial number i at a t-th time instant may be denoted as: Cᵢₜ. In addition, coordinate transformation matrices for transforming the point clouds obtained by the multiple laser radars into the coordinate system corresponding to the traction vehicle may be expressed as T₁, Tᵢ, . . . , T_{N} respectively.

In the embodiments of the present disclosure, the point cloud data obtained by the multiple laser radars at the t-th time instant is transformed into the coordinate system corresponding to the tractor according to the coordinate transformation matrices to obtain a global point cloud C_{wt} corresponding to the t-th time instant. The global point cloud C_{wt} corresponding to the t-th time instant is calculated according to the following equation (1).

$${C}_{w t} = {T}_{1} \times {C}_{1 t} + … + {T}_{i} \times {C}_{i t} + … + {T}_{N} \times {C}_{N t} \qquad ( 1 )$$

In step S220, an object point cloud Cₒₜ corresponding to the t-th time instant is determined based on a rotation matrix corresponding to the t-th time instant and a standard point cloud corresponding to a moving object.

It can be understood that in a scenario where an aircraft is dragged by a traction vehicle to move, the traction vehicle (i.e., the tractor) 12 and the aircraft (i.e., the moving object) 11 are flexibly connected in consideration of factors such as damping of vibration etc.. For example, referring to a flexible connecting part shown in FIG. 3 (the connection is provided with an elastic component, such as a rubber ring, etc.), specifically, a first end 31 of the flexible connecting part may be fixedly connected to the traction vehicle 12, and a second end 32 of the flexible connecting part may be fixedly connected to the aircraft 11.

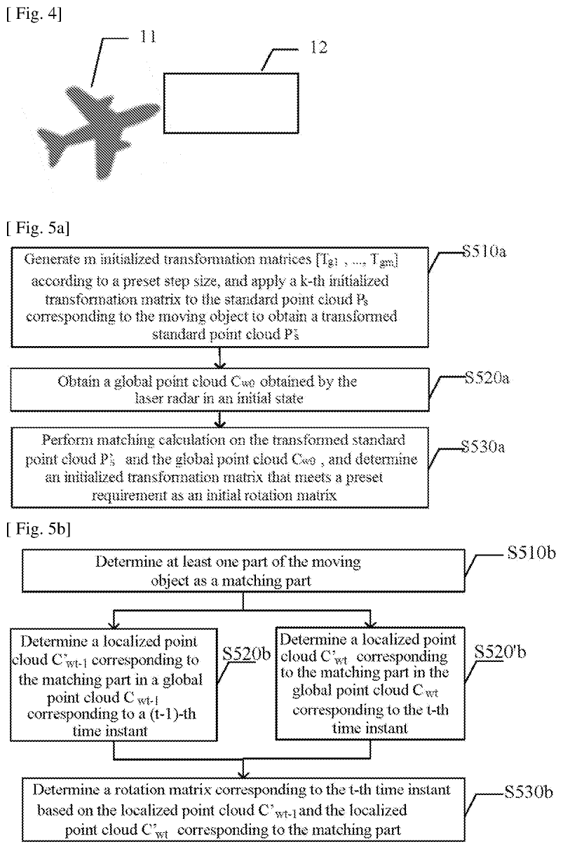

Referring to FIG. 4, in a case that the moving object and the tractor are flexibly connected to each other, the moving object and the tractor (i.e., the aircraft 11 and the traction vehicle 12) may not be consistent in attitude. The obstacle is closely related to a real attitude of the moving object. Therefore, in order to improve the accuracy of detecting an obstacle, it is required to determine a real attitude of the moving object at a t-th time instant. In the embodiments of the present disclosure, it is required to determine a rotation matrix of a current time instant relative to a previous time instant. For example, attitude information of the aircraft at 10: 20: 15 (t-th time instant) is different from attitude information of the aircraft at 10: 20: 10 ((t−1)-th time instant), and the attitude information of the aircraft at 10: 20: 15 (t-th time instant) may be determined by applying a rotation matrix (denoted as a rotation matrix corresponding to the t-th time instant) based on the attitude information at 10: 20: 10 ((t−1)-th time instant). Further, a point cloud reflecting the actual attitude of the moving object at the t-th time instant can be determined based on the standard point cloud of the moving object and the rotation matrix corresponding to the time instant, which is described as the object point cloud Cₒₜ corresponding to the t-th time instant in the embodiments of the present disclosure.

In an exemplary embodiment, taking the moving object being an aircraft as an example. For example, the standard point cloud of the aircraft is represented as Pₛ. It can be understood that aircrafts with different appearances correspond to different standard point clouds respectively. Standard point clouds corresponding to various types of aircraft respectively may be obtained and stored in advance for future use. It should be noted that although the aircraft may include some movable parts such as a propeller of the aircraft, the aircraft includes enough points that can be applied to point cloud matching due to a large size of the aircraft. Therefore, movable parts of the aircraft do not affect the accuracy of detecting an obstacle in the embodiments of the present disclosure.

A method for determining a rotation matrix is described in detail below with reference to FIG. 5a and FIG. 5b.

FIG. 5a is a flowchart of a method for determining a rotation matrix according to an embodiment of the present disclosure. The embodiment shown in the Figure reflects a method for determining a rotation matrix of the moving object in a case that the moving object and the traction vehicle are in a static state. Referring to FIG. 5a:

In step S510a, m initialized transformation matrices [T_{g1}, . . . , T_{gm}] are generated according to a preset step size, and a k-th initialized transformation matrix is applied to the standard point cloud Pₛ corresponding to the moving object to obtain a transformed standard point cloud P′ₛ.

In step S520a, a global point cloud C_{w0} obtained by the laser radar in an initial state is obtained; and in step S530a, matching calculation is performed on the transformed standard point cloud P's and the global point cloud C_{w0}, and an initialized transformation matrix that meets a preset requirement is determined as an initial rotation matrix.

In the initial state, the moving object and the tractor are in a static state.

In an exemplary embodiment, the global point cloud C_{w0} may be determined according to the equation (1). It can be understood that this embodiment reflects that, in the initial state of the traction, since both the traction vehicle and the aircraft are in a static state, point clouds scanned by the laser radar over a long time period may be accumulated in determination of the global point cloud C_{w0}. Since more scanning points are obtained, there are more rich scanning points for matching calculation, which contributes to improve the accuracy of matching.

For example, the global point cloud C_{w0} may be de-noised before the matching calculation. For example, a point cloud below a preset ground height is deleted to reduce interference of a point on the ground point or a point on other obstacle, which contributes to improve the accuracy of matching.

In this solution, in the initial state of the traction, m (which is a positive integer) initialized transformation matrices may be generated according to the preset step size based on a type of the traction vehicle and a model of the aircraft under traction. The m initialized transformation matrices are denoted as [T_{g1}, . . . , T_{gm}]. Further, the k-th (k is less than m) initialized transformation matrix is applied to the standard point cloud Pₛ of the aircraft, which is expressed as an equation (2):

PsTgk=Tgk×Ps (2)

The point cloud P_{sTgk} obtained through transformation and the point clouds C_{w0} scanned the radars in the initial state are registered. C_{w0} represents a set of point clouds obtained by transforming the multiple radars to the same coordinate system (the coordinate system corresponding to the traction vehicle). T_{gk} meeting a preset registration convergence condition and having a minimum registration error is determined as the initial rotation matrix.

For example, in a case that the preset registration convergence condition cannot be met, manual intervention from an operator for the traction vehicle is introduced to achieve precise registration of the standard point cloud and the point cloud in the initial state.

In another exemplary embodiment, the traction vehicle and the aircraft are in a static state in the initial state of the traction, and matching and manual operation in the initial state may be achieved by combining the embodiment shown in FIG. 5A. That is, a manual matching operation is performed on a display interface. Manual matching is intuitive, so that the initial rotation matrix that can realize accurate matching between the global point cloud obtained by the laser radar and the standard point cloud of the aircraft.

FIG. 5b is a flowchart showing a method for determining a rotation matrix according to another embodiment of the present disclosure. The embodiment shown in the Figure reflects a method for determining a rotation matrix of the moving object in a case that the moving object and the tractor are in a movement state. Referring to FIG. 5b:

In step S510b, at least one part of the moving object is determined as a matching part.

On a premise of ensuring that the object point cloud Cₒₜ can reflect a real attitude of the moving object, in order to reduce the amount of calculation, a local part of the moving object is used for matching calculation in the exemplary embodiments of the present disclosure. For example, in a case that the moving object is an aircraft, a nose and wings of the aircraft may be determined as matching parts.

It should be noted that in order to ensure the accuracy of matching throughout the traction, the matching part for matching calculation are consistent at different time instants during the traction.

In step S520b, a localized point cloud C′_{wt-1} corresponding to the matching part is determined in a global point cloud C_{wt-1} corresponding to a (t−1)-th time instant, where t is greater than 1. In step S520′b, a localized point cloud C′_{wt} corresponding to the matching part is determined in the global point cloud C_{wt} corresponding to the t-th time instant.

The localized point cloud C′_{wt-1} is determined based on the point cloud data obtained by the laser radar at the (t−1)-th time instant. A specific implementation is as shown in the embodiment corresponding to step S210 and is not repeated here.

For example, in a case that the moving object is an aircraft, the point cloud corresponding to the matching part is extracted from the global point cloud C_{wt-1}, for example, a point cloud corresponding to the nose of the aircraft and a point cloud corresponding to the wings of the aircraft. In this embodiment, the point cloud corresponding to the matching part is denoted as the localized point cloud C′_{wt-1}. Similarly, a point cloud corresponding to the nose of the aircraft and a point cloud corresponding to the wings of the aircraft are determined in the global point cloud C_{wt} corresponding to t-th time instant to obtain the localized point cloud C′_{wt} corresponding to the matching part.

In step S530b, the rotation matrix corresponding to the t-th time instant is determined based on the localized point cloud C′_{wt-1} and the localized point cloud C′_{wt} corresponding to the matching part.

For example, matching calculation is performed on the localized point cloud C′_{wt-1} and the localized point cloud C′_{wt} corresponding to the nose of the aircraft to obtain a rotation matrix reflecting a relative position change of the aircraft nose between the two time instants. In comparison with directly matching the global point cloud C_{wt-1} and the global point cloud C_{wt}, the localized point clouds are extracted for matching in the embodiments of the present disclosure, so that the amount of calculation can be effectively reduced, which improves a calculation rate, thereby facilitating finding an obstacle in time.

It should be noted that the initial rotation matrix determined through the embodiment shown in FIG. 5a may be determined as a rotation matrix corresponding to a 1st time instant. Further, the rotation matrix (the initial rotation matrix) corresponding to the 1st time instant is added based on an attitude angle corresponding to the moving object in the initial state to obtain an attitude angle of the standard point cloud at the 1st time instant, that is, to obtain an object point cloud Cₒₜ reflecting a real attitude of the moving object at the 1st time instant is obtained.

Further, in the embodiment provided in FIG. 5b, a rotation matrix corresponding to a 2nd time instant is determined based on the localized point cloud C′_{w1} corresponding to the 1st time instant and a localized point cloud C′_{w2} corresponding to the 2nd time instant. Then, the rotation matrix corresponding to the 2nd time instant is added based on the attitude angle corresponding to the 1st time instant to obtain an attitude angle of the standard point cloud at the 2nd time instant, that is, to obtain an object point cloud Cₒ₂ reflecting a real attitude of the moving object at the 2nd time instant. Similarly, a rotation matrix corresponding to a 3rd time instant is determined based on the localized point cloud C′_{w2} corresponding to the 2nd time instant and a localized point cloud C′_{w3} corresponding to the 3rd time instant. Then, a rotation matrix corresponding to the 3rd time instant is applied based on the attitude angle corresponding to the 2nd time instant to obtain an attitude angle of the standard point cloud at the 3rd time instant, that is, to obtain an object point cloud Cₒ₃ reflecting a real attitude of the moving object at the 3rd time instant. By analogy, the object point cloud corresponding to each time instant during the traction can be determined.

Referring to FIG. 2, in step S230, a to-be-measured point cloud C_{dt} corresponding to the t-th time instant is determined based on the global point cloud C_{wt} and the object point cloud Cₒₜ corresponding to the t-th time instant.

The global point cloud C_{wt} is a point cloud captured by the laser radar at the t-th time instant, including the moving object and a potential obstacle. The object point cloud Cₒₜ is a point cloud reflecting the real attitude of the moving object at the t-th time instant. In this embodiment, a part, of the global point cloud C_{wt} that does not belong to the moving object, may be denoted as to-be-measured point cloud C_{dt} corresponding to the t-th time instant.

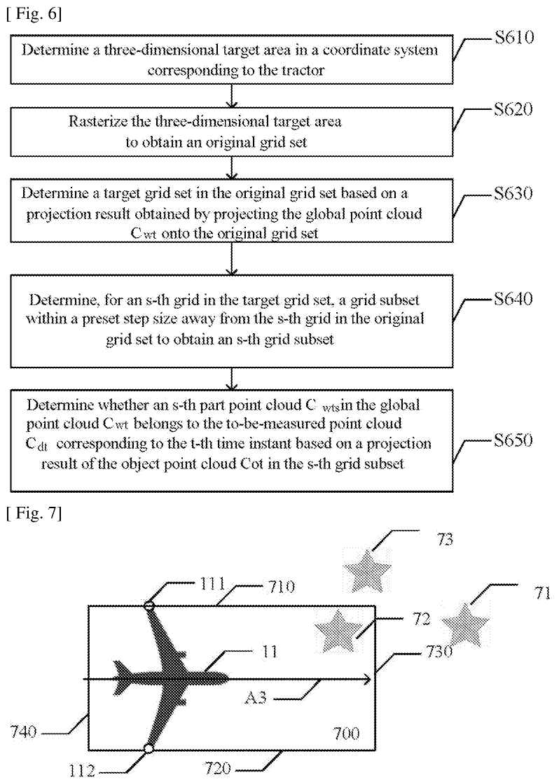

In an exemplary embodiment, FIG. 6 is a flowchart of a method for determining a to-be-measured point cloud according to an embodiment of the present disclosure, which may be used as a specific implementation of step S230. Referring to FIG. 6, in step S610, a three-dimensional target area is determined in the coordinate system corresponding to the tractor.

A size of the three-dimensional target area is related to a maximum envelope size of the moving object at the t-th time instant. For example, since the object point cloud Cₒₜ is a point cloud reflecting the real attitude of the moving object at the t-th time instant, the maximum envelope size of the moving object at the t-th time instant may be determined based on the object point cloud Cₒₜ.

In order to improve the accuracy of detection, preset margin may be set on the basis of the maximum envelope size. The preset margin may be set as needed and is not limited here. In order to facilitate setting, the three-dimensional target area may be set as a cube.

In step S620, the three-dimensional target area is rasterized to obtain an original grid set.

In this embodiment, the three-dimensional target area is rasterized to obtain the original grid set. A three-dimensional grid may be represented by Cellₙₘₖ, where n, m and k represent the number of grids in a length direction, the number of grids in a width direction and the number of grids in a height direction respectively.

In step S630, a target grid set is determined in the original grid set based on a projection result obtained by projecting the global point cloud C_{wt} onto the original grid set.

Each grid in the target grid set includes a projection point cloud of the global point cloud C_{wt}.

In this embodiment, the global point cloud C_{wt} obtained by scanning at the t-th time instant is projected onto the original point cloud set. It can be understood that since the preset margin is set for the three-dimensional target space on the basis of the maximum envelope size, only some of grids in the original grid set include the projection point cloud of the global point cloud C_{wt} and other of the grids in the original grid set include no projection point cloud of the global point cloud C_{wt} after the global point cloud C_{wt} is projected onto the original point cloud set. In this embodiment, the grids that are in the original grid set and include the projection point cloud of C_{wt} are denoted as the “target grid set”.

It can be understood that for an s-th grid in the target grid set, in a case that the grid further includes a projection point cloud of the object point cloud Cₒₜ, it indicates that there is an intersection of the projection point cloud C_{wts} of the global point cloud in the s-th grid and the projection point cloud of the object point cloud in the grid and indicates that the projection point cloud C_{wts} belongs to the moving object and does not belong to the to-be-measured point cloud Ca corresponding to the t-th time instant.

In order to improve the accuracy of determining the to-be-measured point cloud C_{dt}, it cannot be determined that the projection point cloud C_{wts} does not belong to the moving object even if the grid does not include the projection point cloud of the object point cloud Cₒₜ. Instead, the following solutions are provided according to the embodiments of the present disclosure. First, it is determined, with the s-th grid as a center, an area (denoted as an s-th grid subset) within a preset step size away from the s-th grid in the original grid set. Then, it is determined whether an s-th part point cloud C_{wts} in the global point cloud C_{wt} belongs to the point cloud C_{dt} corresponding to the t-th time instant based on a projection result of the object point cloud Cₒₜ in the s-th grid subset. For example, steps S640 and S650 are performed.

In step S640, for the s-th grid in the target grid set, a grid subset within a preset step size away from the s-th grid is determined in the original grid set to obtain an s-th grid subset. In step S650, it is determined whether the s-th part point cloud C_{wts} in the global point cloud C_{wt} belongs to the to-be-measured point cloud C_{dt} corresponding to the t-th time instant based on a projection result of the object point cloud Cot in the s-th grid subset.

In an exemplary embodiment, in a case that there is no projection point cloud of the object point cloud Cₒₜ in the s-th grid subset, it indicates that there is no intersection of the s-th part point cloud C_{wts} in the global point cloud C_{wt} and the object point cloud, and therefore it is determined that the s-th part point cloud C_{wts} in the global point cloud C_{wt} belongs to the to-be-measured point cloud C_{dt} corresponding to the t-th time instant. In a case that there is a projection point cloud of the object point cloud Cₒₜ in the s-th grid subset, it indicates that there is an intersection of the s-th part point cloud C_{wts} in the global point cloud C_{wt} and the object point cloud, and therefore it is determined that the s-th part point cloud C_{wts} in the global point cloud C_{wt} does not belong to the to-be-measured point cloud C_{dt} corresponding to the t-th time instant.

Again, referring to FIG. 2, in step S240, an obstacle for the moving object at the t-th time instant is determined based on the to-be-measured point cloud C_{dt} corresponding to the t-th time instant and a safety area Rt corresponding to the t-th time instant.

For example, referring to FIG. 7, the to-be-measured point cloud C_{dt} corresponding to the t-th time instant may include a point cloud for an object 71 and a point cloud for an object 72. However, it can be seen from FIG. 7 that the object 71 is not an obstacle for the aircraft. Therefore, in this embodiment, a safety area Rt (for example, the area 700 in FIG. 7) corresponding to the time instant is determined, and then the obstacle for the moving object at the t-th time instant is determined based on the to-be-measured point cloud C_{dt} and the safety area Rₜ corresponding to the t-th time instant.

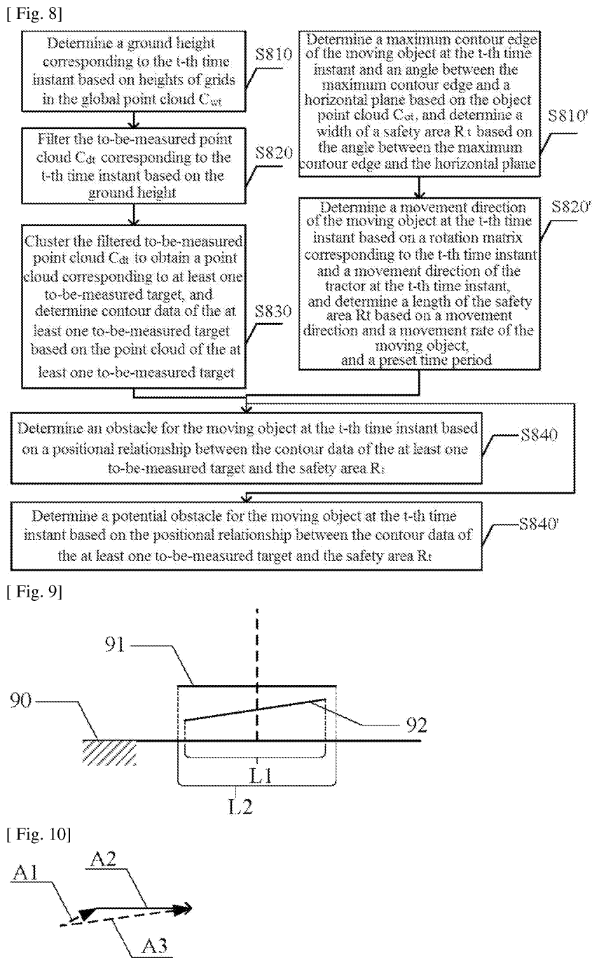

In an exemplary embodiment, FIG. 8 is a flowchart of a method for detecting an obstacle according to another exemplary embodiment of the present disclosure, which may be used as a specific embodiment of step S240. Referring to FIG. 8:

In step S810, a ground height corresponding to the t-th time instant is determined based on heights of grids in the global point cloud C_{wt}. In step S820, the to-be-measured point cloud C_{dt} corresponding to the t-th time instant is filtered based on the ground height.

For example, the ground height may be variable when the aircraft moves under traction. Therefore, at the t-th time instant, the ground height corresponding to the t-th time instant is determined based on the heights of the grids in the global point cloud C_{wt}. For example, a group of grids with a smallest height is determined in the global point cloud C_{wt}. A number of grids in the group of grids may be determined as needed. For example, five to ten grids are selected in this embodiment. Further, a statistical value (for example, a median, a mode, an average, or the like) of the heights of all grids in the group of grids is determined as the ground height corresponding to t-th time instant. Further, the to-be-measured point cloud C_{dt} corresponding to the t-th time instant is filtered based on the ground height.

In S830, the filtered to-be-measured point cloud C_{dt} is clustered to obtain a point cloud corresponding to at least one to-be-measured target, and contour data of the at least one to-be-measured target is determined based on the point cloud of the at least one to-be-measured target.

In an exemplary embodiment, at least one to-be-measured target (for example, the object 71 and the object 72 shown in FIG. 7) is determined based on projection information of the to-be-measured point cloud C_{dt} in the three-dimensional grid. Specifically, clustering is performed in the grid in a four-connected manner or an eight-connected manner. Further, the contour data of each to-be-measured target is calculated based on clusters obtained by clustering. In order to accurately determine an obstacle for the aircraft at a current time instant (for example, to accurately determine that the object 71 is not an obstacle for the aircraft at the current time instant), in this embodiment, in calculation of the contour data of each to-be-measured target, a minimum contour size of the to-be-measured target is calculated.

For example, a j-th to-be-measured target may be expressed as: Object (j)={Pⱼ₁, . . . , Pⱼₖ}.

In the above equation, Pⱼ₁, . . . , Pⱼₖ represent control points of the minimum contour of the j-th to-be-measured target. Each of the control points of the minimum contour may be determined based on a scanning point in a corresponding grid.

In order to further determine whether the to-be-measured target is an obstacle, in the embodiments of the present disclosure, a safety area Rₜ for the moving object is determined in steps S810′ to S820′. Further, it is determined whether the to-be-measured target is an obstacle based on the relationship between the safety area Rₜ and the minimum contour of the to-be-measured target.

In an exemplary embodiment, on the one hand, a width of the safety area Rₜ is determined in step S810′:

In step S810′, a maximum contour edge of the moving object at the t-th time instant and an angle between the maximum contour edge and a horizontal plane are determined based on the object point cloud Cₒₜ, and a width of the safety area R is determined based on the angle between the maximum contour edge and the horizontal plane.

The object point cloud Cₒₜ corresponding to the t-th time instant can reflect an actual attitude of the current moving object, so that a maximum contour size (which may be denoted as “the longest edge”) of the moving object and the angle between “the longest edge” and the horizontal plane can be determined based on the object point cloud Cₒₜ. For example, in a case that the moving object is an aircraft, a distance between the outermost points of the two wings (referring to a safety point 111 and a safety point 112 in FIG. 7) is the maximum contour size of the aircraft (“the longest edge”). Further, the angle between “the longest edge” and the horizontal plane is determined based on an attitude angle of the aircraft. The angle between “the longest edge” and the horizontal plane is an influence factor for the safety area.

For example, referring to FIG. 9, 91 represents “the longest edge” of the aircraft in the vertical plane without a turning angle, and the width of the safety area determined based on “the longest edge” 91 is L2. 92 represents “the longest edge” of the aircraft having a turning angle (an included angle with the horizontal plane 90) in the vertical plane, and the width of the safety area determined based on “the longest edge” 92 is L1. It can be seen that an attitude of “the longest edge” of the moving object affects the width of the safety area. Accordingly, a safety line 710 and a safety line 720 as shown in FIG. 7 can be determined, so as to determine the width of the safety area Rₜ.

On the other hand, a length of the safety area Rₜ is determined in step S820′:

In step S820′, a movement direction of the moving object at the t-th time instant is determined based on a rotation matrix corresponding to the t-th time instant and a movement direction of the tractor at the t-th time instant, and a length of the safety area Rₜ is determined based on a movement direction and a movement rate of the moving object, and a preset time period

For example, the movement direction of the moving object at this time instant is determined: determining the movement direction of the moving object at the t-th time instant based on the rotation matrix corresponding to the t-th time instant and a movement direction of the tractor at the t-th time instant. For example, referring to FIG. 10, a relative movement direction A1 of the moving object relative to the traction device (e.g., a relative movement direction A1 of the aircraft relative to the traction vehicle) is determined based on the rotation matrix corresponding to the t-th time instant. A direction A2 represents the movement direction of the tractor. Further, a movement direction A3 of the moving object at this time instant may be determined based on the relative movement direction A1 and the movement direction A2.

It is further required to determine the movement rate of the moving object at this time instant. For example, the movement rate of the tractor may serve as the movement rate of the moving object at this time instant.

After determination of the movement direction and the movement rate of the moving object at this time instant and a short preset time period (e.g., 2 seconds), a movement trajectory of the moving object during the preset time period can be determined, and then a safety line 730 of the safety area Rₜ is determined. Further, after setting preset margin based on a position of the tail of the aircraft, a safety line 740 parallel to the safety line 730 can be determined, and the length of the safety area Rₜ can be determined based on the safety line 730 and the safety line 740.

In the exemplary embodiment, in a case that the moving object is an aircraft under traction, the computation device may obtain, at a high frequency through a CAN bus of the traction vehicle, the movement direction (e.g., the direction A2 in FIG. 10) and the movement rate (e.g., for determining the safety line 730 in combination with the movement direction A2 of the moving object) of the vehicle, so as to rapidly determine the safety area Rₜ.

After determination the width and the length of the safety area Rₜ in steps S810′ and S820′, the safe area Rₜ can be determined.

Referring to FIG. 8, after determination of the safety area, step S840 is performed: determining the obstacle for the moving object at the t-th time instant based on a positional relationship between the contour data of at least one to-be-measured target and the safety area Rₜ.

In an exemplary embodiment, in a case of the positional relationship indicating that there is an intersection between a contour of at least one to-be-measured target and the safety area Rₜ, the to-be-measured target, for which there is an intersection, is determined as the obstacle for the moving object at the t-th time instant. For example, referring to FIG. 7, there is an intersection between the to-be-measured target 72 and the safety area Rₜ, which indicates that the to-be-measured target 72 is in the movement trajectory of the aircraft, and therefore it is determined that the to-be-measured target 72 is an obstacle.

Referring to FIG. 8, after determination of the safety area, step S840′ is further performed: a potential obstacle for the moving object at the t-th time instant is determined based on the positional relationship between the contour data of the at least one to-be-measured target and the safety area Rₜ.

In an exemplary embodiment, a to-be-measured target for which there is no intersection is determined as the potential obstacle for the moving object at the t-th time instant. For example, referring to FIG. 7, there is no intersection between the to-be-measured target 71 and the safety area Rₜ and there is no intersection between the to-be-measured target 73 and the safety area Rₜ. In this embodiment, the to-be-measured target 71 and the to-be-measured target 73 may be determined as potential obstacles for the moving object at the t-th time instant. Further, a time period it takes for the moving object to reach the potential obstacle and/or turning information are calculated.

For example, a time period it takes for the moving object to collide with the potential obstacle (the to-be-measured target 71) is calculated as t1 seconds based on a current movement rate of the moving object. Based on the current movement speed and the current movement direction of the moving object, a time period it takes for the moving object to collide with the potential obstacle (the to-be-measured target 73) is calculated as t2 seconds and the moving object is required to turn counterclockwise by s degrees. By setting calculations related to the potential obstacle, early warning can be achieved, which is conducive to adjusting a traction direction in advance, thereby improving traction efficiency.

For example, the warning information may be displayed in a display screen or reminded by voice. For example, the warning information may be, with the current movement direction and the current movement rate, it will collide with the potential obstacle (the to-be-measured target 71) after t1 seconds. For another example, the warning information may be, with the current movement rate and with turning counterclockwise based on the current movement direction by s degrees, it will collide with the potential obstacle (the to-be-measured target 73) after t2 seconds.

It can be seen that with the solution for detecting an obstacle according to the embodiments of the present disclosure, the obstacle corresponding to the t-th time instant can be automatically detected, and the solution has a high accuracy in detecting an obstacle. In addition, a potential obstacle corresponding to the t-th time instant can further be determined, and further early warning information about the potential obstacle can be automatically generated, which can effectively guide the traction. Therefore, with the technical solution, the traction efficiency can be improved while ensuring the safety of the moving object.

It should be noted that the drawings are only schematic illustrations of the processing included in the method according to the exemplary embodiments of the present invention, and are not intended for limiting purposes. It is easy to understand that the processing shown in the drawings does not indicate or limit a chronological order of these processes. In addition, it is also easy to understand that these processes may be implemented synchronously or asynchronously in multiple modules, for example.

Embodiments of device according to the present disclosure are described below, and the device may be used to implement the embodiments of the method according to the present disclosure. For details not disclosed in the embodiment of the device according to the present disclosure, reference may be made to the embodiments of the method according to the present disclosure.

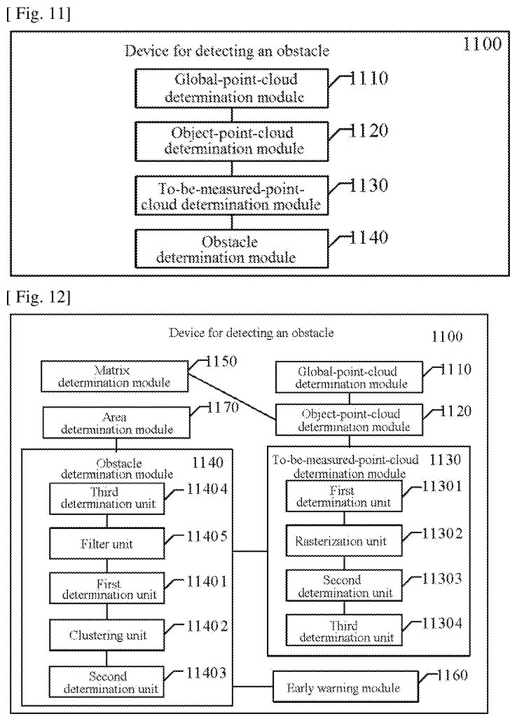

FIG. 11 is a schematic structural diagram of a device for detecting an obstacle according to an embodiment of the present disclosure. Referring to FIG. 11, the device for detecting an obstacle shown in this Figure may be implemented as all or part of an electronic device through software, hardware or a combination thereof, and may also be integrated into an electronic device or a server as an independent module.

The device 1100 for detecting an obstacle in the embodiments of the present disclosure includes a global-point-cloud determination module 1110, an object-point-cloud determination module 1120, a to-be-measured-point-cloud determination module 1130, and an obstacle determination module 1140.

The global-point-cloud determination module 1110 is configured to determine a global point cloud C_{wt} corresponding to a t-th time instant based on point cloud data obtained by a laser radar at the t-th time instant, where t is a positive integer. The object-point-cloud determination module 1120 is configured to determine an object point cloud Cₒₜ corresponding to the t-th time instant based on a rotation matrix corresponding to the t-th time instant and a standard point cloud corresponding to a moving object. The to-be-measured-point-cloud determination module 1130 is configured to determine a to-be-measured point cloud C_{dt} corresponding to the t-th time instant based on the global point cloud C_{wt} and the object point cloud Cₒₜ corresponding to the t-th time instant. The obstacle determination module 1140 is configured to determine an obstacle for the moving object at the t-th time instant based on the to-be-measured point cloud C_{dt} corresponding to the t-th time instant and a safety area Rₜ corresponding to the t-th time instant.

In an exemplary embodiment, FIG. 12 is a schematic structural diagram of a device for detecting an obstacle according to another embodiment of the present disclosure. Referring to FIG. 12:

In an exemplary embodiment, based on the above solutions, the laser radar is arranged on the tractor, and the tractor is flexibly connected to the moving object. The global-point-cloud determination module 1110 is specifically configured to transform the point cloud data obtained by the laser radar at the t-th time instant into a point cloud data in a coordinate system corresponding to the tractor according to a coordinate transformation matrix between the laser radar and the tractor to obtain the global point cloud C_{wt} corresponding to the t-th time instant.

In an exemplary embodiment, based on the above solutions, the device 1100 for detecting an obstacle further includes a matrix determination module 1150.

The matrix determination module 1150 is configured to, before the object-point-cloud determination module 1120 determines the object point cloud Cₒₜ corresponding to the t-th time instant based on the rotation matrix corresponding to the t-th time instant and the standard point cloud corresponding to the moving object, determine at least one part of the moving object as a matching part, determine a localized point cloud C′_{wt-1} corresponding to the matching part in a global point cloud C_{wt1} corresponding to a (t−1)-th time instant, where t is greater than 1, determine a localized point cloud C′_{wt} corresponding to the matching part in the global point cloud C_{wt} corresponding to the t-th time instant, and determine the rotation matrix corresponding to the t-th time instant based on the localized point cloud C′_{wt-1} and the localized point cloud C′_{wt} corresponding to the matching part.

In an exemplary embodiment, based on the above solutions, before the object-point-cloud determination module 1120 determines the object point cloud Cₒₜ corresponding to the t-th time instant based on the rotation matrix corresponding to the t-th time instant and the standard point cloud corresponding to the moving object, the matrix determination module 1150 is further configured to generate m initialized transformation matrices [T_{g1}, . . . , T_{gm}] according to a preset step size, and apply a k-th initialized transformation matrix to the standard point cloud Pₛ corresponding to the moving object to obtain a transformed standard point cloud P′ₛ where m is a positive integer and k is an integer not greater than m; obtain a global point cloud C_{w0} obtained by the laser radar in an initial state; and perform matching calculation on the transformed standard point cloud P′ₛ and the global point cloud C_{w0}, and determine an initialized transformation matrix that meets a preset requirement as an initial rotation matrix.

In an exemplary embodiment, based on the above solutions, the to-be-measured-point-cloud determination module 1130 includes a first determination unit 11301, a rasterization unit 11302, a second determination unit 11303, and a third determination unit 11304.

The first determination unit 11301 is configured to determine a three-dimensional target area in the coordinate system corresponding to the tractor, where a size of the three-dimensional target area is related to a maximum envelope size of the moving object at the t-th time instant. The rasterization unit 11302 is configured to rasterize the three-dimensional target area to obtain an original grid set. The second determination unit 11303 is configured to determine a target grid set in the original grid set based on a projection result obtained by projecting the global point cloud C_{wt} onto the original grid set, where each grid in the target grid set includes a projection point cloud of the global point cloud C_{wt}. The second determination unit 11303 is further configured to determine, for the s-th grid in the target grid set, a grid subset within a preset step size away from the s-th grid in the original grid set to obtain an s-th grid subset. The third determination unit 11304 is further configured to determine whether the s-th part point cloud C_{wts} in the global point cloud C_{wt} belongs to the to-be-measured point cloud C_{dt} corresponding to the t-th time instant based on a projection result of the object point cloud Cot in the s-th grid subset, where the s-th part point cloud C_{wt}, is a projection point cloud of the global point cloud C_{wt} in the s-th grid.

In an exemplary embodiment, based on the above solutions, the third determination unit 11304 is specifically configured to determine that the s-th part point cloud C_{wts} in the global point cloud Cm belongs to the to-be-measured point cloud C_{dt} corresponding to the t-th time instant in a case that there is no projection point cloud of the object point cloud Cₒₜ in the s-th grid subset, and determine that the s-th part point cloud C_{wts} in the global point cloud C_{wt} does not belong to the to-be-measured point cloud C_{dt} corresponding to the t-th time instant in a case that there is a projection point cloud of the object point cloud Cₒₜ in the s-th grid subset.

In an exemplary embodiment, based on the above solutions, the device further includes an area determination module 1170.

The area determination module 1170 is configured to determine a maximum contour edge of the moving object at the t-th time instant and an angle between the maximum contour edge and a horizontal plane based on the object point cloud Cₒₜ, and determine a width of the safety area Rₜ based on the angle between the maximum contour edge and the horizontal plane; and determine a movement direction of the moving object at the t-th time instant based on a rotation matrix corresponding to the t-th time instant and a movement direction of the tractor at the t-th time instant, and determine a length of the safety area Rₜ based on the movement direction and a movement rate of the moving object, and a preset time period; and determine the safety area Rₜ corresponding to the t-th time instant based on the width and the length of the safety area Rₜ.

In an exemplary embodiment, based on the above solutions, the obstacle determination module 1140 includes a first determination unit 11401, a clustering unit 11402, and a second determination unit 11403.

The first determination unit 11401 is configured to determine the safety area Rₜ corresponding to the t-th time instant. The clustering unit 11402 is configured to cluster the to-be-measured point cloud C_{dt} to obtain a point cloud corresponding to at least one to-be-measured target, and determine contour data of the at least one to-be-measured target based on the point cloud of the at least one to-be-measured target. The second determination unit 11403 is configured to determine the obstacle for the moving object at the t-th time instant based on a positional relationship between the contour data of the at least one to-be-measured target and the safety area Rₜ.

In an exemplary embodiment, based on the above solutions, the obstacle determination module 1140 includes a third determination unit 11404 and a filter unit 11405.

The third determination unit 11404 is configured to, before the clustering unit 11402 clusters the to-be-measured point cloud C_{dt}, determine a ground height corresponding to the t-th time instant based on heights of grids in the global point cloud C_{wt}. The filter unit 11405 is configured to filter the to-be-measured point cloud C_{dt} corresponding to the t-th time instant based on the ground height, where the filtered to-be-measured point cloud C_{dt} is used for performing the clustering.

In an exemplary embodiment, based on the above solutions, the second determination unit 11403 is specifically configured to determine, in a case of the positional relationship indicating that there is an intersection between a contour of at least one to-be-measured target and the safety area Rₜ, the at least one to-be-measured target as the obstacle for the moving object at the t-th time instant.

In an exemplary embodiment, based on the above solutions, the device 1100 for detecting an obstacle further includes an early warning module 1160.

The early warning module 1160 is configured to determine a to-be-measured target having a contour not intersecting with the safety area Rₜ as a potential obstacle for the moving object at the t-th time instant, and determine warning information about the potential obstacle based on a relative position between the potential obstacle and the moving object, and movement information of the moving object.

It should be noted that, when the device for detecting an obstacle according to the above embodiments implement the method for detecting an obstacle, it is illustrated with an example of division of the function modules. In practice, the function distribution may be finished by different function modules as neededs. That is, the internal structure of the device is divided into different function modules, so as to finish all or part of the functions described above. In addition, the device for detecting an obstacle and the method for detecting an obstacle according to the above embodiments belong to a same idea. Therefore, for details not disclosed in the device embodiments of the present disclosure, reference is made to the above embodiments of the method for detecting an obstacle in the present disclosure, and the details are not repeated here.

The sequence numbers of the embodiments of the present disclosure are merely for description purpose, and do not indicate the preference among the embodiments.

A computer-readable storage medium is further provided according to the embodiments of the present disclosure. The computer-readable storage medium stores a computer program that, when executed by a processor, causes the method according to any one of the previous embodiments to be implemented. The computer-readable storage medium may include, but is not limited to, any type of disk, including floppy disk, optical disk, DVD, CD-ROM, micro drive, magneto-optical disk, ROM, RAM, EPROM, EEPROM, DRAM, VRAM, flash memory device, magnetic card or optical card, nano system (including molecular memory IC), or any type of medium or device applicable to storing instructions and/or data.

An electronic device is further provided according to an embodiment of the present disclosure. The electronic device includes a memory, a processor, and a computer program stored on the memory and executable by the processor. The processor executes the program to implement the method according to any one of the above embodiments.

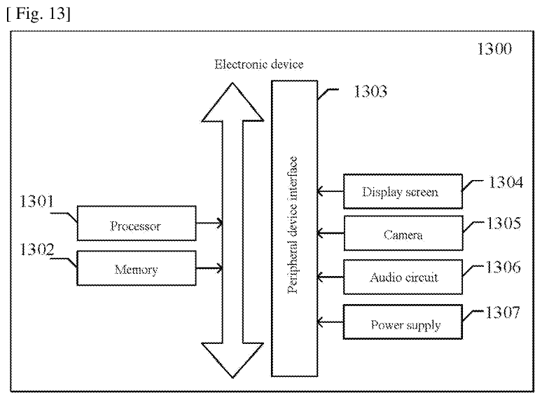

FIG. 13 is a schematic structural diagram of an electronic device according to an embodiment of the present disclosure. As shown in FIG. 13, the electronic device 1300 includes a processor 1301 and a memory 1302.

In the embodiments of the present disclosure, the processor 1301 is a control center of a computer system, which may be a processor of a physical machine or a processor of a virtual machine. The processor 1301 may include one or more processing cores, for example, a 4-core processor or an 8-core processor. The processor 1301 may adopt at least one hardware form among the DSP (digital signal processing), the FPGA (field-programmable gate array), and the PLA (programmable logic array). The processor 1301 may further include a main processor and a coprocessor. The main processor is configured to process data in a wake-up state, and is also referred to as a central processing unit (CPU). The coprocessor is a low-power processor configured to process data in a standby mode.

In the embodiments of the present disclosure, the processor 1301 is specifically configured to: determine a global point cloud C_{wt} corresponding to a t-th time instant based on point cloud data obtained by a laser radar at the t-th time instant, where t is a positive integer; determine an object point cloud Cₒₜ corresponding to the t-th time instant based on a rotation matrix corresponding to the t-th time instant and a standard point cloud corresponding to a moving object; determine a to-be-measured point cloud Car corresponding to the t-th time instant based on the global point cloud C_{wt} and the object point cloud Cₒₜ corresponding to the t-th time instant; determine an obstacle for the moving object at the t-th time instant based on the to-be-measured point cloud C_{dt} corresponding to the t-th time instant and a safety area Rₜ corresponding to the t-th time instant.

Further, the laser radar is arranged on a tractor, and the tractor is flexibly connected to the moving object.

The determining of the global point cloud C_{wt} corresponding to the t-th time instant based on the point cloud data obtained by the laser radar at the t-th time instant comprises: transforming the point cloud data obtained by the laser radar at the t-th time instant into a point cloud data in a coordinate system corresponding to the tractor according to a coordinate transformation matrix between the laser radar and the tractor to obtain the global point cloud C_{wt} corresponding to the t-th time instant.

Further, the processor 1301 is further configured to, before the object point cloud Cₒₜ corresponding to the t-th time instant is determined based on the rotation matrix corresponding to the t-th time instant and the standard point cloud corresponding to the moving object, determine at least one part of the moving object as a matching part, determine a localized point cloud C′_{wt-1} corresponding to the matching part in a global point cloud C_{wt-1} corresponding to a (t−1)-th time instant, where t is greater than 1, determine a localized point cloud C′_{wt} corresponding to the matching part in the global point cloud C_{wt} corresponding to the t-th time instant, and determine the rotation matrix corresponding to the t-th time instant based on the localized point cloud C′_{wt-1} and the localized point cloud C′_{wt} corresponding to the matching part.

Further, the processor 1301 is further configured to, before the object point cloud Cₒₜ corresponding to the t-th time instant is determined based on the rotation matrix corresponding to the t-th time instant and the standard point cloud corresponding to the moving object, generate m initialized transformation matrices [T_{g1}, . . . , T_{gm}] according to a preset step size, and apply a k-th initialized transformation matrix to the standard point cloud Pₛ corresponding to the moving object to obtain a transformed standard point cloud P′ₛ where m is a positive integer and k is an integer not greater than m; obtain a global point cloud C_{w0} obtained by the laser radar in an initial state; and perform matching calculation on the transformed standard point cloud P′ₛ and the global point cloud C_{w0}, and determine an initialized transformation matrix that meets a preset requirement as an initial rotation matrix.

Further, the determining of the to-be-measured point cloud C_{dt} corresponding to the t-th time instant based on the global point cloud C_{wt} and the object point cloud Cₒₜ corresponding to the t-th time instant comprises: determining a three-dimensional target area in the coordinate system corresponding to the tractor, where a size of the three-dimensional target area is related to a maximum envelope size of the moving object at the t-th time instant; rasterizing the three-dimensional target area to obtain an original grid set; determining a target grid set in the original grid set based on a projection result obtained by projecting the global point cloud C_{wt} onto the original grid set, where each grid in the target grid set includes a projection point cloud of the global point cloud C_{wt} determining, for the s-th grid in the target grid set, a grid subset within a preset step size away from the s-th grid in the original grid set to obtain an s-th grid subset; determining whether the s-th part point cloud C_{wts} in the global point cloud C_{wt} belongs to the to-be-measured point cloud C_{dt} corresponding to the t-th time instant based on a projection result of the object point cloud Cₒₜ in the s-th grid subset, where the s-th part point cloud C_{wts} is a projection point cloud of the global point cloud C_{wt} in the s-th grid.

Further, the determining of whether the s-th part point cloud C_{wts} in the global point cloud C_{wt} belongs to the to-be-measured point cloud C_{dt} corresponding to the t-th time instant based on a projection result of the object point cloud Cₒₜ in the s-th grid subset comprises: determining that the s-th part point cloud C_{wts} in the global point cloud C_{wt} belongs to the to-be-measured point cloud C_{dt} corresponding to the t-th time instant in a case that there is no projection point cloud of the object point cloud Cₒₜ in the s-th grid subset, and determining that the s-th part point cloud C_{wts} in the global point cloud C_{wt} does not belong to the to-be-measured point cloud C_{dt} corresponding to the t-th time instant in a case that there is a projection point cloud of the object point cloud Cₒₜ in the s-th grid subset.

Further, the processor 1301 is further configured to, before the obstacle for the moving object at the t-th time instant is determined based on the to-be-measured point cloud C_{dt} corresponding to the t-th time instant and the safety area Rₜ corresponding to the t-th time instant, determine a maximum contour edge of the moving object at the t-th time instant and an angle between the maximum contour edge and a horizontal plane based on the object point cloud Cₒₜ, and determine a width of the safety area Rₜ based on the angle between the maximum contour edge and the horizontal plane; and determine a movement direction of the moving object at the t-th time instant based on a rotation matrix corresponding to the t-th time instant and a movement direction of the tractor at the t-th time instant, and determine a length of the safety area Rₜ based on the movement direction and a movement rate of the moving object, and a preset time period; and determine the safety area Rₜ corresponding to the t-th time instant based on the width and the length of the safety area Rₜ.

Further, the determining of the obstacle for the moving object at the t-th time instant based on the to-be-measured point cloud C_{dt} corresponding to the t-th time instant and the safety area Rₜ corresponding to the t-th time instant comprises: determining the safety area Rₜ corresponding to the t-th time instant; clustering the to-be-measured point cloud C_{dt} to obtain a point cloud corresponding to at least one to-be-measured target, and determining contour data of the at least one to-be-measured target based on the point cloud of the at least one to-be-measured target; determining the obstacle for the moving object at the t-th time instant based on a positional relationship between the contour data of the at least one to-be-measured target and the safety area Rₜ.

Further, the processor 1301 is further configured to, before the to-be-measured point cloud C_{dt} is clustered, determine a ground height corresponding to the t-th time instant based on heights of grids in the global point cloud C_{wt}; filter the to-be-measured point cloud C_{dt} corresponding to the t-th time instant based on the ground height, where the filtered to-be-measured point cloud C_{dt} is used for performing the clustering.

Further, the determining of the obstacle for the moving object at the t-th time instant based on a positional relationship between the contour data of the at least one to-be-measured target and the safety area Rₜ comprises: determining, in a case of the positional relationship indicating that there is an intersection between a contour of at least one to-be-measured target and the safety area Rₜ, the at least one to-be-measured target as the obstacle for the moving object at the t-th time instant

Further, the processor 1301 is further configured to: determine a to-be-measured target having a contour not intersecting with the safety area Rₜ as a potential obstacle for the moving object at the t-th time instant; and determine, after the obstacle for the moving object at the t-th time instant is determined based on the to-be-measured point cloud C_{dt} corresponding to the t-th time instant and the safety area Rₜ corresponding to the t-th time instant, warning information about the potential obstacle based on a relative position between the potential obstacle and the moving object, and movement information of the moving object.

The memory 1302 may include one or more computer-readable storage media, and may be non-transitory. The memory 1302 may further include a high-speed random access memory and a non-volatile memory, such as one or more magnetic disk storage devices and one or more flash memory storage devices. In some embodiments of the present disclosure, a non-transitory computer-readable storage medium in the memory 1302 is configured to store at least one instruction, and the at least one instruction is configured to be executed by the processor 1301 to implement the method according to the embodiments of the present disclosure.

In some embodiments, the electronic device 1300 further includes a peripheral device interface 1303 and at least one peripheral device. The processor 1301, the memory 1302, and the peripheral device interface 1303 may be connected through a bus or a signal cable. Each peripheral devices may be connected to the peripheral device interface 1303 through a bus, a signal cable, or a circuit board. Specifically, the peripheral device includes at least one of a display screen 1304, a camera 1305 and an audio circuit 1306.

The peripheral device interface 1303 may be configured to connect at least one peripheral device related to input/output (I/O) to the processor 1301 and the memory 1302. In some embodiments of the present disclosure, the processor 1301, the memory 1302 and the peripheral device interface 1303 are integrated on a same chip or circuit board. In other embodiments of the present disclosure, any one or two of the processor 1301, the memory 1302, and the peripheral device interface 1303 may be implemented on a single chip or circuit board, which is not limited in the embodiments of the present disclosure.

The display screen 1304 is configured to display a user interface (UI). The UI may include a graph, a text, an icon, a video, and any combination thereof. In a case that the display screen 1304 is a touchscreen, the display screen 1304 is further capable of acquiring a touch signal on or above a surface of the display screen 1304. The touch signal may be inputted to the processor 1301 as a control signal for processing. In this case, the display screen 1304 may be further configured to provide a virtual button and/or a virtual keyboard, which is also referred to as a soft button and/or a soft keyboard. In some embodiments of the present disclosure, there may be one display screen 1304, arranged on a front panel of the electronic device 1300. In other embodiments of the present disclosure, there may be at least two display screens 1304, which are arranged on different surfaces of the electronic device 1300 respectively or designed in a foldable shape. In some embodiments of the present disclosure, the display screen 1304 may be a flexible display screen arranged on a curved surface or a folded surface of the electronic device 1300. Even, the display screen 1304 may be further set in a non-rectangular irregular pattern, namely, a special-shaped screen. The display screen 1304 may be made of a material such as a liquid crystal display (LCD), an organic light-emitting diode (OLED), or the like.

The camera 1305 is configured to acquire an image or a video. Optionally, the camera 1305 includes a front camera and a rear camera. Usually, the front camera is arranged on a front panel of the electronic device, and the rear camera is arranged on the back of the electronic device. In some embodiments, there are at least two rear cameras, each of which may be any one of a main camera, a depth of field camera, a wide-angle camera, and a telephoto camera, so that the main camera and the depth of field camera are fused to realize a background virtualization function, and the main camera and the wide-angle camera are fused to realize a panorama shooting function, a virtual reality (VR) shooting function or other fusion shooting function. In some embodiments of the present disclosure, the camera 1305 may further include a flash light. The flash light may be a single-color-temperature flash light, or may be a double-color-temperature flash light. The double-color-temperature flash light refers to a combination of a warm-light flash light and a cold-light flash light, and may be used for light compensation under different color temperatures.

The audio circuit 1306 may include a microphone and a speaker. The microphone is configured to acquire a sound wave from the user and the environment, convert the sound wave into an electrical signal and input the electrical signal to the processor 1301 for processing. For stereo acquisition or noise reduction, there may be multiple microphones, which are arranged at different portions of the electronic device 1300 respectively. The microphone may also be an array microphone or an omnidirectional acquisition microphone.

The power supply 1307 is configured to supply power for various components in the electronic device 1300. The power supply 1307 may be an alternating current, a direct current, a primary battery, or a rechargeable battery. In a case that the power supply 1307 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charge technology.

The structural block diagram of the electronic device shown in the embodiments of the present disclosure does not constitute a limit to the electronic device 1300. The electronic device 1300 may include more or less components than that shown in the diagram, or some combined components, or adopt a different arrangement of components.

In the description of the present disclosure, it should be understood that the terms “first”, “second” and the like are only for illustrative purpose rather than construed as indicating or implying relative importance. For those skilled in the art, the specific meaning of the above terms in the present disclosure may be understood in the light of specific circumstances. In addition, in the description of the present disclosure, “multiple” means two or more unless otherwise stated. And/or describes an association relationship for describing associated objects and represents that three relationships may exist. For example, A and/or B may represent the following three cases: only A exists, both A and B exist, and only B exists. The symbol “/” generally indicates that a former object and a latter object are associated by an “or” relationship.

The above are only specific implementations of the present disclosure, but the protection scope of the present disclosure is not limited thereto. Changes and substitutions which may be easily contemplated by those skilled in the art within the technical scope disclosed in the present disclosure shall fall within the protection scope of the present disclosure. Therefore, equivalent variations made in accordance with the claims of the present disclosure still fall within the scope of the present disclosure.

1. A method for detecting an obstacle, comprising:
determining a global point cloud C_{wt} corresponding to a t-th time instant based on point cloud data obtained by a laser radar at the t-th time instant, wherein t is a positive integer;
determining an object point cloud Cₒₜ corresponding to the t-th time instant based on a rotation matrix corresponding to the t-th time instant and a standard point cloud corresponding to a moving object;
determining a to-be-measured point cloud C_{dt} corresponding to the t-th time instant based on the global point cloud C_{wt} and the object point cloud Cₒₜ corresponding to the t-th time instant; and
determining an obstacle for the moving object at the t-th time instant based on the to-be-measured point cloud C_{dt} corresponding to the t-th time instant and a safety area Rₜ corresponding to the t-th time instant.

2. The method according to claim 1, wherein the laser radar is arranged on a tractor, and the tractor is flexibly connected to the moving object; and
the determining of the global point cloud C_{wt} corresponding to the t-th time instant based on point cloud data obtained by the laser radar at the t-th time instant comprises:
transforming the point cloud data obtained by the laser radar at the t-th time instant into a point cloud data in a coordinate system corresponding to the tractor according to a coordinate transformation matrix between the laser radar and the tractor, to obtain the global point cloud C_{wt} corresponding to the t-th time instant.

3. The method according to claim 1, wherein before the determining of the object point cloud Cₒₜ corresponding to the t-th time instant based on the rotation matrix corresponding to the t-th time instant and the standard point cloud corresponding to the moving object, further comprises:
generating m initialized transformation matrices [T_{g1}, . . . , T_{gm}] according to a preset step size and applying a k-th initialized transformation matrix to a standard point cloud Pₛ corresponding to the moving object, to obtain a transformed standard point cloud P′ₛ, wherein m is a positive integer and k is an integer not greater than m;
obtaining a global point cloud C_{w0} obtained by the laser radar in an initial state; and
performing matching calculation on the transformed standard point cloud P′ₛ and the global point cloud C_{w0}, and determining an initialized transformation matrix that meets a preset requirement as an initial rotation matrix.

4. The method according to claim 1, wherein the determining of the to-be-measured point cloud C_{dt} corresponding to the t-th time instant based on the global point cloud C_{wt} and the object point cloud Cₒₜ corresponding to the t-th time instant comprises:
determining a three-dimensional target area in a coordinate system corresponding to the tractor, wherein a size of the three-dimensional target area is related to a maximum envelope size of the moving object at the t-th time instant;
rasterizing the three-dimensional target area to obtain an original grid set;
determining a target grid set in the original grid set based on a projection result obtained by projecting the global point cloud C_{wt} onto the original grid set, wherein each grid in the target grid set comprises a projection point cloud of the global point cloud C_{wt};
determining, for an s-th grid in the target grid set, a grid subset within a preset step size from the s-th grid in the original grid set to obtain an s-th grid subset; and
determining whether an s-th part point cloud C_{wts} in the global point cloud C_{wt} belongs to the to-be-measured point cloud C_{dt} corresponding to the t-th time instant based on a projection result of the object point cloud Cₒₜ in the s-th grid subset,
wherein the s-th part point cloud C_{wts} is a projection point cloud of the global point cloud C_{wt} in the s-th grid.

5. The method according to claim 4, wherein the determining whether the s-th part point cloud C_{wts} in the global point cloud C_{wt} belongs to the to-be-measured point cloud C_{dt} corresponding to the t-th time instant based on the projection result of the object point cloud Cₒₜ in the s-th grid subset comprises:
determining that the s-th part point cloud C_{wts} in the global point cloud C_{wt} belongs to the to-be-measured point cloud C_{dt} corresponding to the t-th time instant in a case that there is no projection point cloud of the object point cloud Cₒₜ in the s-th grid subset, and
determining that the s-th part point cloud C_{wts} in the global point cloud C_{wt} does not belong to the to-be-measured point cloud C_{dt} corresponding to the t-th time instant in a case that there is a projection point cloud of the object point cloud Cₒₜ in the s-th grid subset.

6. The method according to claim 1, wherein before the determining of the obstacle for the moving object at the t-th time instant based on the to-be-measured point cloud C_{dt} corresponding to the t-th time instant and the safety area Rₜ corresponding to the t-th time instant, the method further comprises:
determining a maximum contour edge of the moving object at the t-th time instant and an angle between the maximum contour edge and a horizontal plane based on the object point cloud Cₒₜ, and determining a width of the safety area Rₜ based on the angle between the maximum contour edge and the horizontal plane;
determining a movement direction of the moving object at the t-th time instant based on a rotation matrix corresponding to the t-th time instant and a movement direction of the tractor at the t-th time instant, and determining a length of the safety area Rₜ based on the movement direction and a movement rate of the moving object, and a preset time period; and
determining the safety area Rₜ corresponding to the t-th time instant based on the width and the length of the safety area Rₜ.

7. The method according to claim 1, wherein the determining of the obstacle for the moving object at the t-th time instant based on the to-be-measured point cloud C_{dt} corresponding to the t-th time instant and a safety area Rₜ corresponding to the t-th time instant comprises:
clustering the to-be-measured point cloud C_{dt} to obtain a point cloud corresponding to at least one to-be-measured target, and determining contour data of the at least one to-be-measured target based on the point cloud of the at least one to-be-measured target; and
determining the obstacle for the moving object at the t-th time instant based on a positional relationship between the contour data of the at least one to-be-measured target and the safety area Rₜ.

8. A device for detecting an obstacle, comprising:
a global-point-cloud determination module configured to determine a global point cloud C_{wt} corresponding to a t-th time instant based on point cloud data obtained by a laser radar at the t-th time instant, wherein t is a positive integer;
an object-point-cloud determination module configured to determine an object point cloud Cₒₜ corresponding to the t-th time instant based on a rotation matrix corresponding to the t-th time instant and a standard point cloud corresponding to a moving object;
a to-be-measured-point-cloud determination module configured to determine a to-be-measured point cloud C_{dt} corresponding to the t-th time instant based on the global point cloud C_{wt} and the object point cloud Cₒₜ corresponding to the t-th time instant; and
an obstacle determination module configured to determine an obstacle for the moving object at the t-th time instant based on the to-be-measured point cloud C_{dt} corresponding to the t-th time instant and a safety area Rₜ corresponding to the t-th time instant.

9. An electronic device comprising a memory, a processor, and a computer program stored on the memory and executable by the processor, wherein the processor executes the computer program to implement the method for detecting an obstacle according to claim 1.

10. A computer-readable storage medium storing a computer program, wherein the computer program is executed by a processor to implement the method for detecting an obstacle according to claim 1.

11. The device according to claim 8, wherein the laser radar is arranged on a tractor, and the tractor is flexibly connected to the moving object; and
the global-point-cloud determination module is further configured to:
transform the point cloud data obtained by the laser radar at the t-th time instant into a point cloud data in a coordinate system corresponding to the tractor according to a coordinate transformation matrix between the laser radar and the tractor, to obtain the global point cloud Cwt corresponding to the t-th time instant.

12. The device according to claim 8, further comprising:
a standard point cloud transformation module configured to generate m initialized transformation matrices [Tg1, . . . , Tgm] according to a preset step size and apply a k-th initialized transformation matrix to a standard point cloud Ps corresponding to the moving object, to obtain a transformed standard point cloud P′s, wherein m is a positive integer and k is an integer not greater than m;
a global point cloud obtaining module configured to obtain a global point cloud Cw0 obtained by the laser radar in an initial state; and
an initial rotation matrix determination module configured to perform matching calculation on the transformed standard point cloud P′s and the global point cloud Cw0, and determine an initialized transformation matrix that meets a preset requirement as an initial rotation matrix.

13. The device according to claim 8, wherein the to-be-measured-point-cloud determination module is further configured to:
determine a three-dimensional target area in a coordinate system corresponding to the tractor, wherein a size of the three-dimensional target area is related to a maximum envelope size of the moving object at the t-th time instant;
rasterize the three-dimensional target area to obtain an original grid set;
determine a target grid set in the original grid set based on a projection result obtained by projecting the global point cloud Cwt onto the original grid set, wherein each grid in the target grid set comprises a projection point cloud of the global point cloud Cwt;
determine for an s-th grid in the target grid set, a grid subset within a preset step size from the s-th grid in the original grid set to obtain an s-th grid subset; and
determine whether an s-th part point cloud Cwts in the global point cloud Cwt belongs to the to-be-measured point cloud Cdt corresponding to the t-th time instant based on a projection result of the object point cloud Cot in the s-th grid subset,
wherein the s-th part point cloud Cwts is a projection point cloud of the global point cloud Cwt in the s-th grid.

14. The device according to claim 13, wherein the to-be-measured-point-cloud determination module is further configured to:
determine that the s-th part point cloud Cwts in the global point cloud Cwt belongs to the to-be-measured point cloud Cdt corresponding to the t-th time instant in a case that there is no projection point cloud of the object point cloud Cot in the s-th grid subset, and
determine that the s-th part point cloud Cwts in the global point cloud Cwt does not belong to the to-be-measured point cloud Cdt corresponding to the t-th time instant in a case that there is a projection point cloud of the object point cloud Cot in the s-th grid subset.

15. The device according to claim 8, further comprising:
a width determination module configured to determine a maximum contour edge of the moving object at the t-th time instant and an angle between the maximum contour edge and a horizontal plane based on the object point cloud Cot, and determine a width of the safety area Rt based on the angle between the maximum contour edge and the horizontal plane;
a length determination module configured to determine a movement direction of the moving object at the t-th time instant based on a rotation matrix corresponding to the t-th time instant and a movement direction of the tractor at the t-th time instant, and determine a length of the safety area Rt based on the movement direction and a movement rate of the moving object, and a preset time period; and
a safety area determination module configured to determine the safety area Rt corresponding to the t-th time instant based on the width and the length of the safety area Rt.

16. The device according to claim 8, wherein the obstacle determination module is further configured to:
cluster the to-be-measured point cloud Cdt to obtain a point cloud corresponding to at least one to-be-measured target, and determine contour data of the at least one to-be-measured target based on the point cloud of the at least one to-be-measured target; and
determine the obstacle for the moving object at the t-th time instant based on a positional relationship between the contour data of the at least one to-be-measured target and the safety area Rt.
